(19) United States
(12) Patent Application Publication
(10) Pub. No.: US 2007/0053792 A1
(43) Pub. Date: Mar. 8, 2007

(54) AUTOMATIC SAMPLER

(75) Inventor: Yoshiaki Maeda, Kyoto-shi, Kyoto (JP)

Correspondence Address: RANKIN, HILL, PORTER & CLARK LLP, 4080 ERIE STREET, WILLOUGHBY, OH, 44094-7836, US

(73) Assignee: SHIMADZU CORPORATION, Kyoto-shi (JP)

(21) Appl. No.: 11/457,643

(22) Filed: Jul. 14, 2006

(30) Foreign Application Priority Data
Sep. 2, 2005 (JP) 2005-254765

(51) Int. Cl. B01L 3/02

(52) U.S. Cl. 422/63; 422/100

(57) ABSTRACT

An automatic sampler including a rinsing unit for rinsing a needle 2 by immersing the needle 2 into a rinsing solution in a rinsing chamber 1 and a gas injecting unit for injecting gas towards an outer surface of the needle 2 when the needle 2 is raised from the rinsing solution. According to this configuration, it is possible to wipe out a contaminated rinsing solution remaining on the outer surface of the needle 2 by airflow in a non-contact manner.

### TECHNICAL FIELD

The present disclosure relates to an automatic sampler for introducing samples into various kinds of analytic devices including a liquid chromatograph, and more particularly, to the automatic sampler having a needle rinsing unit for rinsing a needle for injecting samples.

### RELATED ART

Hereinafter, an example of the liquid chromatograph will be described. In the liquid chromatography analysis, an automatic sampler introduces samples by inserting a needle into a sample vessel containing samples therein, sucking a prescribed amount of samples into the needle, and holding the sucked samples in the needle and a sample loop connected to the needle. Thereafter, the needle is transported to an injection port so as to inject samples into the injection port. In the course of this operation, since residual samples remaining after the preceding injections might adhere to the needle, thereby causing cross-contamination and eventually disturbing measurement, the needle should be rinsed before the next injection operation. The rinsing operation is performed by immersing the needle into a rinsing solution in a rinsing chamber (also called as a rinsing port), details of which are disclosed in Japanese Patent Unexamined Publication No. 9-127078 (which is referred as Patent Document 1) as a related art. The rinsing solution in the rinsing chamber may be appropriately replaced by a manual operation or may be automatically replaced by a pump for every injection operation.

FIG. 3 shows an example of the rinsing chamber according to a related-art automatic sampler.

The rinsing chamber in FIG. 3 is an example of a rinsing chamber which automatically replaces the rinsing solution. In the figure, reference numeral 1 indicates a rinsing chamber. The rinsing chamber 1 includes an opening 11 and a rinsing solution introduction port 12. The opening 11 is formed on a top portion of the rinsing chamber 1, and receives a needle 2 to be rinsed. The rinsing solution introduction port 12 is formed on a bottom portion of the rinsing chamber 1, and introduces the rinsing solution. In addition, the rinsing chamber 1 includes a rinsing solution discharge port 13 for discharging the rinsing solution by overflowing the rinsing solution from the lateral surface of the rinsing chamber 1. By the rinsing solution discharge port 13, the liquid level of the rinsing solution in the rinsing chamber 1 is maintained substantially constant.

Details of the rinsing operation of the needle 2 in the rinsing chamber 1 are disclosed in the Patent Document 1, which can be briefly summarized as follows.

First, the rinsing solution is supplied from the rinsing solution introduction port 12 to the rinsing chamber 1 by a pump (not shown) connected to the rinsing solution introduction port 12 through valves and conduits (either of which are not shown in the figure). As a result, the used rinsing solution in the rinsing chamber 1 is discharged from the rinsing solution discharge port 13 and is replaced with an unused rinsing solution.

Thereafter, the needle 2 is transported to the opening 11 and inserted into the rinsing chamber 1 through the opening 11 at the top portion of the rinsing chamber 1 so that the needle 2 is immersed in the rinsing solution, whereby it is possible to rinse the outer surface of the needle 2. The inner surface of the needle 2 can be rinsed by flowing the rinsing solution into the needle 2, details of which are not closely related to the present invention and will not be described herein.

After the rinsed needle 2 is raised from the rinsing solution, the needle 2 is transported to a sample vessel (not shown), samples in the sample vessel are sucked by the needle 2 and the sucked samples are injected into the injection port (not shown) whereby a sampling operation is performed, as described above.

In the related-art rinsing unit, the rinsing solution remains adhered to the outer surface of the needle even after the needle is rinsed by the rinsing unit. Although the rinsing solution adhered to the needle might be considerably diluted, since the rinsing solution may contain contaminant materials (which are the samples remaining after the preceding sampling operations), the contaminant materials might be mixed into a sample for next sampling operation thereby causing the cross-contamination. Accordingly, there is a possibility that the adhered rinsing solution has an adverse effect on quantitative capability and reproducibility of the analysis. Moreover, there may be cases in which the contaminant materials once melted in the rinsing solution are re-adhered to the outer surface of the needle, thereby becoming a cause of the cross-contamination.

According to another example of a related-art rinsing chamber, the opening of the rinsing chamber is sealed by a septum (not shown) such as a silicon rubber. In order to rinse the needle, the needle should pass through the septum so as to insert the needle into the rinsing chamber. In this case, the main purpose of the septum lies in preventing the vaporization of the rinsing solution, but the septum is also effective in wiping out the contaminated rinsing solution remaining on the outer surface of the rinsed needle. The septum serves as a wiping member for wiping out the contaminated rinsing solution, however, there have been occasions in which the wiped-out rinsing solution remaining adhered to the septum was transferred to the needle in the next rinsing operation, thereby becoming a cause of the cross-contamination.

### SUMMARY

Embodiments of the present invention provide an automatic sampler capable of reducing an amount of a rinsing solution remaining on an outer surface of a rinsed needle and preventing cross-contamination caused by the remaining rinsing solution.

According to an aspect of one or more embodiments of the invention, an automatic sampler includes a rinsing unit for rinsing a needle by immersing the needle into a rinsing solution in a rinsing chamber and a gas injecting unit for injecting gas towards an outer surface of the needle when the needle is raised from the rinsing solution. According to this configuration, it is possible to wipe out a contaminated rinsing solution remaining on the outer surface of the needle by airflow in a non-contact manner.

Various implementations may include one or more the following advantages. For example, it is possible to reduce the possibility of the cross-contamination caused by the contaminated rinsing solution remaining on the outer surface of the needle by reducing the amount of the rinsing solution remaining on the outer surface of the rinsed needle. In addition, since the contaminated rinsing solution on the outer surface of the needle is wiped out in a non-contact manner, there is no possibility of the cross-contamination caused by the wiping member.

### BRIEF DESCRIPTION OF THE DRAWINGS

FIG. 1 is a view showing an embodiment according to the present invention.

FIG. 2 is a view showing another embodiment according to the present invention.

FIG. 3 is a view showing an example according to a related art.

### DETAILED DESCRIPTION

The automatic sampler according to the present invention is characterized in that gas is injected toward the needle when the needle is raised from the rinsing solution. The automatic sampler according to an exemplary embodiment of the present invention includes a gas injecting unit for injecting gas towards an outer surface of the needle when the needle is raised from the rinsing solution as a basic configuration.

### Embodiment 1

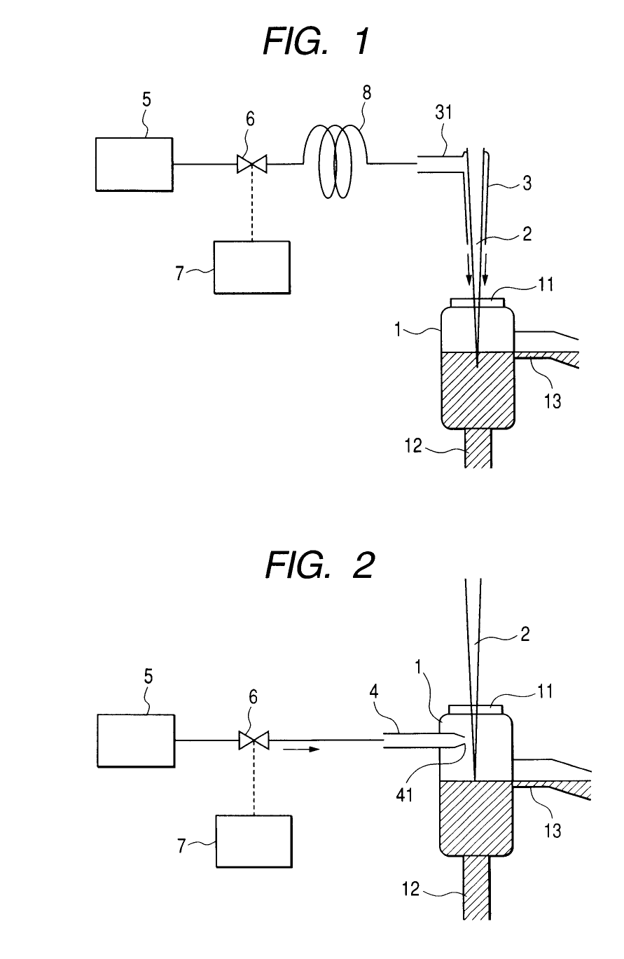

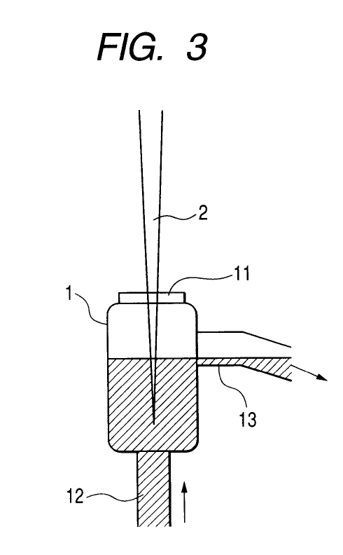

Hereinafter, an embodiment of the invention will be described with reference to FIG. 1. In the figure, parts having the same functions as those of FIG. 3 are represented by the same reference numbers and the descriptions thereof will be omitted.

The present embodiment is primarily different from the related art illustrated in FIG. 3 in that there is provided an outer tube 3 which covers a rear end portion of the needle 2 (top portion thereof in FIG. 1) so that the needle 2 and the outer tube 3 constitutes a duplex tube configuration. The outer tube 3 has a lower end portion opened to atmosphere and a top end portion closed. A branch pipe 31 is formed close to the top end portion of the outer tube 3 and connected to the outer tube 3. An air source 5 (for example, an air compressor) is connected to the branch pipe 31 through an electronic valve 6. A flexible pipe 8 having a high flexibility is disposed as a connection pipe between the electronic valve 6 and the branch pipe 31 to allow the needle 2 to freely move. For example, a pressure-resistant plastic pipe wound in a coil shape can be used for the flexible pipe 8. The needle 2 is movable in both vertical and horizontal directions by a moving device not shown in the figure.

Hereinafter, operations of the present embodiment will be described.

After sampling a sample, a needle 2 is inserted into a rinsing chamber 1 by a moving device not shown in the figure, for example, a moving device movable by a combination of rack and pinion gears, and is immersed in the rinsing solution in the rinsing chamber 1. Up to this point, the present embodiment is identical to the related art. The electronic valve 6 is opened substantially simultaneously when the rinsed needle 2 is raised from the rinsing solution. As a result, compressed air discharged from the air source 5 is supplied to the outer tube 3 through the electronic valve 6, the flexible pipe 8, and the branch pipe 31. The compressed air is discharged from the lower end portion of the outer tube 3, thereby forming airflow flowing downwards along the outer surface of the needle 2 as indicated by arrows in the figure. Consequently, the rinsing solution remaining on the outer surface of the needle 2 is blown away by the airflow. In other words, the rinsing solution is wiped out by the airflow in a non-contact manner. After finishing raising the needle 2 from the rinsing solution, the electronic valve 6 is closed to stop the air discharging. Thereafter, the needle 2 is transported to the sample vessel for the next sampling.

The electronic valve 6 is closed or opened under the control of a control unit 7. The control unit 7 controls the entire automatic sampler as well as the electronic valve 6. The closing or opening of the electronic valve 6 is controlled by one of a series of sequence controls of the entire automatic sampler by the control unit 7.

### Embodiment 2

Hereinafter, another embodiment of the invention will be described with reference to FIG. 2. In the figure, parts having the same functions as those of FIG. 1 are represented by the same reference numbers and the descriptions thereof will be omitted.

The present embodiment is identical to Embodiment 1 in that the air discharging is used to wipe out the rinsing solution remaining on the outer surface of the needle 2, but is characterized in that an air discharging port is fixedly formed in the rinsing chamber 1. More specifically, as illustrated in FIG. 2, a discharge pipe 4 is inserted and disposed in the sidewall of the rinsing chamber 1 at a higher position than the liquid level of the rinsing chamber 1. In addition, the discharge pipe 4 has an injection port 41 in the front end thereof to extend toward a center axis of the rinsing chamber 1. The present embodiment is identical to Embodiment 1 in that the air source 5 is connected to the discharge pipe 4 through the electronic valve 6. However, the flexible pipe 8 of Embodiment 1 is not required between the discharge pipe 4 and the electronic valve 6 in the present embodiment since the discharge pipe 4 is fixed to the rinsing chamber 1.

The operations of the present embodiment are substantially similar to that of Embodiment 1. When the rinsed needle 2 is raised from the rinsing solution, the rinsing solution remaining on the outer surface of the needle 2 is wiped out by discharging compressed air from the discharge pipe 4.

The present embodiment can be easily constructed in comparison to Embodiment 1 since the flexible pipe 8 is not required in the present embodiment. However, the positioning of the needle 2 should be controlled with high precision since the effect of wiping out is deteriorated when the position of the needle 2 in the rinsing chamber 1 deviates from the front end of the discharge pipe 4 thereby preventing the airflow from reaching the needle 2.

Although, in the embodiments of the present invention, the case where the present invention is applied to the automatic sampler for use in the liquid chromatograph is described, the present invention is not limited to this embodiment and can be applied to the automatic sampler for use in other kinds of analytic devices using liquid samples. In addition, another gas other than air may be used to wipe out the rinsing solution remaining on the outer surface of the needle 2.

In Embodiment 2, in order to enhance the effect of wiping out the rinsing solution remaining on the surface of the needle 2, various variations are possible in the present invention. For example, the discharge pipe 4 may be inclined downward therefrom or another discharge pipe may be additionally provided at an opposite side of the discharge pipe.

The present invention can be employed in an automatic sampler for introducing samples into various kinds of analytic devices including a liquid chromatograph.

What is claimed is:

1. An automatic sampler for sequentially sampling a liquid sample from a plurality of sample vessels by using a needle, the automatic sampler comprising:
a rinsing unit for rinsing the needle by immersing the needle into a rinsing solution in a rinsing chamber; and
a gas injecting unit for injecting gas towards an outer surface of the rinsed needle.

2. The automatic sampler according to claim 1, wherein the gas injecting unit comprises a gas injection port provided on the needle and a compressed air source connected to the gas injection port.

3. The automatic sampler according to claim 1, wherein the gas injecting unit comprises a gas injection port provided in the rinsing chamber and a compressed air source connected to the gas injection port.
